(19) United States
(12) Patent Application Publication
(10) Pub. No.: US 2025/0112685 A1
(43) Pub. Date: Apr. 3, 2025

(54) SYSTEMS AND METHODS FOR IMPLEMENTING SECURE REMOTE IDENTIFICATION OF UNMANNED AIRBORNE VEHICLES

(71) Applicant: AURA Network Systems, Inc., McLean, VA (US)

(72) Inventors: Michael Robert GAGNE, Monrovia, MD (US); Tamara Lynne CASEY, Annapolis, MD (US)

(21) Appl. No.: 18/905,998

(22) Filed: Oct. 3, 2024

Related U.S. Application Data
(60) Provisional application No. 63/587,642, filed on Oct. 3, 2023.

(51) Int. Cl. H04B 7/185

(52) U.S. Cl. CPC H04B 7/18504

(57) ABSTRACT

Disclosed herein are systems and methods for implementing secure and remote location identification for UAVs and other aerial vehicles. A system for tracking the location of one or more UAVs flying within a given geographic area includes one or more ground-based transceivers that are distributed throughout the geographic area. Each transceiver is communicatively coupled to a common controller that is configured to coordinate operation of the system. The common controller causes each of the ground-based transceivers to transmit an interrogation signal that is received by one or more aircraft flying within the geographic coverage area of the system. The interrogation signal includes transmit control information that the aircraft must comply with when sending a response signal to the ground-based transceivers. Compliance with the transmit control information is used to authenticate the aircraft.

### CROSS REFERENCE TO RELATED APPLICATIONS

This application claims the benefit of U.S. Provisional Application No. 63/587,642, filed Oct. 3, 2023, the content of which is herein incorporated by reference in its entirety for all purposes.

### FIELD

The present disclosure relates generally to systems and methods for securely identifying and tracking unmanned aerial vehicles.

### BACKGROUND

Conventional large aircraft use various technologies such as Automatic Dependent Surveillance-Broadcast (ADS-B) technology to periodically broadcast their geographic position thereby allowing for the aircraft to be tracked. In technologies such as ADS-B, the periodicity of the broadcast from an aircraft to an ADS-B receiver is known and at least in part is a major reason that an ADS-B signal is vulnerable to spoofing or other malicious activities by a third-party or malicious actor.

In the context of low-altitude (i.e., ˜400 ft and below) unmanned aerial vehicles (UAV), employing a system such as ADS-B may not be feasible due to the possible large number of UAVs in a given geographic area, and the radio frequency (RF) congestion that may be caused when a large number of UAVs simultaneously or near-simultaneously broadcast location information to one or more receivers on the ground.

### SUMMARY

Disclosed herein are systems and methods for implementing secure and remote location identification for UAVs and other aerial vehicles. In one or more examples, a system for tracking the location of one or more UAVs flying within a given geographic area includes one or more ground-based transceivers that are distributed throughout the geographic area. In some examples, each transceiver is communicatively coupled to a common controller that is configured to coordinate operation of the system. In one or more examples, the common controller causes each of the ground-based transceivers to transmit an interrogation signal that is received by one or more aircraft flying within the geographic coverage area of the system. The interrogation signal includes an address portion that enables an airborne transceiver that is located on each aircraft of the one or more aircraft to recognize when a given interrogation signal is specifically addressing the airborne transceiver, or whether the interrogation signal is meant for another aircraft.

In some examples, the interrogation signal also includes transmit control information that includes one or more specifications for the manner and time at which the airborne transceiver is to transmit a response signal to the interrogation signal. In response to receiving the interrogation signal and determining that the interrogation signal is meant for the airborne transceiver, the airborne transceiver prepares a response signal that includes location information (such as latitude, longitude, and/or identification information). The airborne transceiver, after preparing the response signal as described above, transmits the response signal in accordance with the transmit control information received as part of the interrogation signal. For instance, the airborne transceiver transmits the response signal at a particular frequency and modulation scheme that is specified by the transmit control information found as part of the received interrogation signal. Additionally, in one or more examples, the airborne transceiver transmits the response signal according to a timing sequence that is also specified by the transmit control information.

In one or more examples, one or more of the ground-based transceivers receives the response signal transmitted by the airborne transceivers and (via the common controller) determines if the received response signal complies with the transmit control information that was sent as part of the interrogation signal. In response to determining that the received response signal complies with the transmit control information, the common controller extracts the location information that was transmitted as part of the response signal and associates the location information with the aircraft that is associated with the airborne transceiver that transmitted the response signal.

In some examples, the compliance of the received response signal with the transmit control information can be used to authenticate the response signal, thereby ensuring that the response signal was transmitted from an aircraft that is operating in the geographic area (and is not a spoofed message from a malicious actor or other third-party). In some examples, the transaction between the ground-based transceiver and the airborne transceiver can be stored on a distributed ledger that is maintained by both the ground-based transceiver (via the common controller) and the airborne transceiver. In some examples, the transaction is added to the distributed ledger in response to a determination that the received response signal complies with the transmit control information.

### BRIEF DESCRIPTION OF THE FIGURES

The invention will now be described, by way of example only, with reference to the accompanying drawings, in which:

FIG. 1 illustrates an exemplary aircraft remote identification system according to one or more examples of the disclosure.

FIG. 2 illustrates an exemplary aircraft transceiver for receiving and transmitting remote identification transmissions according to one or more examples of the disclosure.

FIG. 3 illustrates an exemplary process for tracking an aerial vehicle using an aircraft remote tracking system according to one or more examples of the disclosure.

FIG. 4 illustrates an exemplary process implemented by an airborne transceiver for providing tracking information to an aircraft remote tracking system according to one or more examples of the disclosure.

FIG. 5 illustrates an exemplary distributed ledger system according to examples of the disclosure.

FIG. 6 illustrates an exemplary process for operating a distributed ledger system associated with an aircraft remote identification network according to one or more examples of the disclosure.

FIG. 7 illustrates an exemplary computing system, according to examples of the disclosure.

### DETAILED DESCRIPTION

Reference will now be made in detail to implementations and examples of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are systems and methods for implementing secure and remote location identification for UAVs and other aerial vehicles. In one or more examples, a system for tracking the location of one or more UAVs flying within a given geographic area includes one or more ground-based transceivers that are distributed throughout the geographic area. In some examples, each transceiver is communicatively coupled to a common controller that is configured to coordinate operation of the system. In one or more examples, the common controller causes each of the ground-based transceivers to transmit an interrogation signal that is received by one or more aircraft flying within the geographic coverage area of the system. The interrogation signal includes an address portion that enables an airborne transceiver that is located on each aircraft of the one or more aircraft to recognize when a given interrogation signal is specifically addressing the airborne transceiver, or whether the interrogation signal is meant for another aircraft.

In some examples, the interrogation signal also includes transmit control information that includes one or more specifications for the manner and time at which the airborne transceiver is to transmit a response signal to the interrogation signal. In response to receiving the interrogation signal and determining that the interrogation signal is meant for the airborne transceiver, the airborne transceiver prepares a response signal that includes location information (such as latitude, longitude, and/or identification information). The airborne transceiver, after preparing the response signal as described above transmits the response signal in accordance with the transmit control information received as part of the received interrogation signal. For instance, the airborne transceiver transmits the response signal at a particular frequency and modulation scheme that is specified by the transmit control information found as part of the received interrogation signal. Additionally, in one or more examples, the airborne transceiver transmits the response signal according to a timing sequence that is also specified by the transmit control information.

In one or more examples, one or more of the ground-based transceivers receives the response signal transmitted by the airborne transceivers and (via the common controller) determines if the received response signal complies with the transmit control information that was sent as part of the interrogation signal. In response to determining that the received response signal complies with the transmit control information, the common controller extracts the location information that was transmitted as part of the response signal and associates the location information with the aircraft that is associated with the airborne transceiver that transmitted the response signal.

In some examples, the compliance of the received response signal with the transmit control signal can be used to authenticate the response signal, thereby ensuring that the response signal was transmitted from an aircraft that is operating in the geographic area (and is not a spoofed message from a malicious actor or other third-party). In some examples, the transaction between the ground-based transceiver and the airborne transceiver can be stored on a distributed ledger that is maintained by both the ground-based transceiver (via the common controller) and the airborne transceiver. In some examples, the transaction is added to the distributed ledger in response to a determination that the received response signal complies with the transmit control information.

In the following description of the various examples, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Current aircraft tracking technology is not secure and thus often requires validation by radar that can corroborate any location information that is transmitted from an aircraft. However, in the case of low flying aircraft such as some UAVs, corroboration by radar is not possible given the limitations of radar at low altitudes. Furthermore, certain technologies such as ADS-B (described above) rely on aircraft periodically broadcasting their location information asynchronously with respect to one another, which in situations where there are many aircraft flying in the same geographic coverage area, can lead to RF congestion and signal collisions that frustrate or prevent a controller on the ground from ascertaining the location of an aircraft based on the location information transmitted by the aircraft.

In some examples, current aircraft tracking technology are vulnerable to spoofing. For instance, in the ADS-B context, signals transmitted from an aircraft according to the ADS-B standard do not include any authentication mechanisms that allow for a ground-based controller to ascertain whether a received message with location information is authentically from the aircraft it is purported to be from. Described below are systems and methods for providing secure remote identification and tracking of aircraft that provides a mechanism for authentication messages while simultaneously allowing for the coordination of signals from aircraft that minimizes RF congestion.

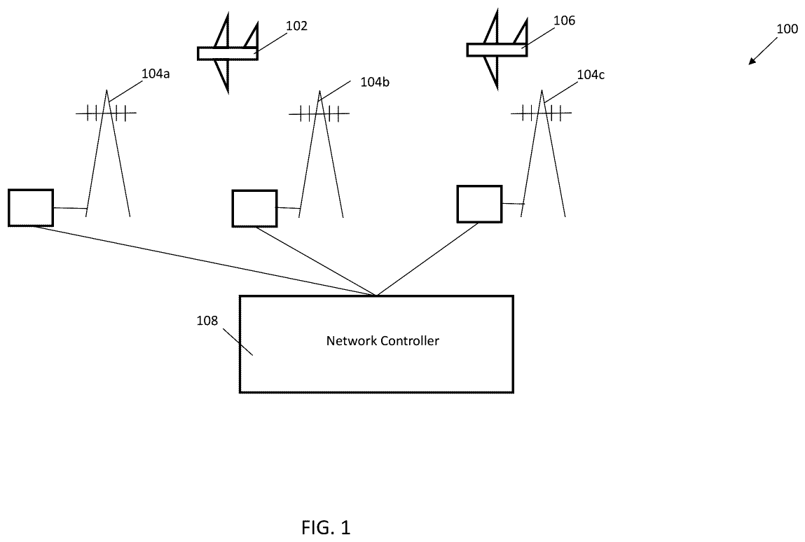

FIG. 1 illustrates an exemplary aircraft remote identification system according to one or more examples of the disclosure. The exemplary system 100 of FIG. 1 includes one or more ground-based transceivers 104a-c that are distributed across a given geographic coverage area associated with the system 100. While the example of FIG. 1 illustrates three ground-based transceivers 104a-c, the number of ground-based transceivers in the network is not so limited and can include any number of transceivers needed to cover all or at least part of the geographic coverage area associated with the system 100. In one or more examples, each ground-based transceiver 104a-c can include a transmitter for transmitting one or more interrogation signals (described in detail below) and can include one or more receivers for receiving one or more response signals from one or more aircraft 102 flying through the coverage area of the system 100. In some examples, the receiver and the transmitter associated with each ground-based transceiver 104a-c can be co-located in common locations as illustrated in the example of FIG. 1. Additionally or alternatively, the receiver and transmitter associated with a transceiver can be located in different locations within the geographic coverage area of the system 100. In some examples, multiple receivers can be associated with a common transmitter, and multiple transmitters can be associated with a common receiver.

In one or more examples, the ground-based transceivers 104a-c can be implemented using preexisting communications infrastructure such as a two-way paging network. A two-way paging network lends itself to being used for the secure remote identification of aircraft because the low-latency two-way paging network can precisely coordinate (from a time perspective) the timing and method of transmission of signals across the network. In contrast, other types of communications infrastructure such as cellular networks operate on standards that do not allow for coordinated (e.g. on demand) transmission of signals within the network required to perform the methods described herein. In one or more examples, the ground-based transceivers 104a-c can operate as transceivers within a two-way paging network that is configured to receive and transmit communications signals with one or more ground-based pagers that are part of the network. In addition, the same ground-based transceivers can be switched to operate as ground-based transceivers within a system such as system 100 for securely and remotely tracking aircraft as described herein. As such, the ground-based transceivers can operate as time-division multiple access (TDMA) base stations allocating time slots for TDMA communication with both terrestrial pagers and airborne assets.

In one or more examples, each ground-based transceiver 104a-c can be communicatively coupled to a network controller 108 that coordinates operation of the system 100. For instance, controller 108 can coordinate the transmission of one or more interrogation signals (described in detail further below) to the aircraft 102 flying in the coverage area of the system 100. In one or more examples, controller 108 can prepare the content of an interrogation signal. For instance, controller 108 can generate transmit control information (described in further detail below) as well as address information (also described in further detail below), and embed both the transmit control information and address information into an interrogation signal. In some examples, the controller 108 after constructing the interrogation as described above, can coordinate the broadcast of the interrogation signal amongst the ground-based transceivers 104a-c such that the interrogation signal is transmitted to the one or more aircraft 102 flying within the coverage area of the system 100.

In one or more examples, controller 108 can also cause the one or more transceivers to also operate as transceivers in a two-way paging network as described above. In one or more examples, controller 108 can determine when the ground-based transceivers 104a-c should operate as transceivers in a two-way paging network (e.g., receive traffic from and transmit traffic to one or more two-way pagers located throughout the network) or operate as ground-based transceivers in a system configured to track the location of an aircraft such as system 100. Additionally or alternatively, controller 108 can also cause the one or more transceivers 104a-c to operate as a multi-static radar network similar to the network described with respect to U.S. Provisional Patent Application 63/502,274 which is incorporated herein by reference in its entirety. In one or more examples, ground-based transceivers 104a-c can operate as a single frequency network in which one or more of the transceivers 104a-c broadcast the same signal over the same frequency simultaneously. In one or more examples, the operation of transceivers 104a-c as a single frequency network can be synchronized by controller 108 or another external clock such as that provided by a global positioning system (GPS) network. Synchronizing the operations of transceivers 104a-c allow ground-based transceivers 104a-c to maximize the coverage area they cover and reduce spectral congestion in a given geographic area covered by the ground-based transceivers. In one or more examples, ground-based transceivers 104a-c can be operated as a single frequency network (described above) when operating as a paging network, a multi-static radar network, and for performing secure remote identification for aircraft as described above.

In one or more examples, each of the aircraft 102 flying within the coverage area of the system can be equipped with its own transceiver that can operate similarly to a two-way pager in a traditional two-way paging network. In some examples, and as described in further detail below, the transceivers on each aircraft 102 are configured to receive interrogation signals from the one or more ground-based transceivers 104a-c of system 100 and transmit messages to one or more of the ground-based transceivers in accordance with transmit control information included as part of the interrogation signal as described in further detail below.

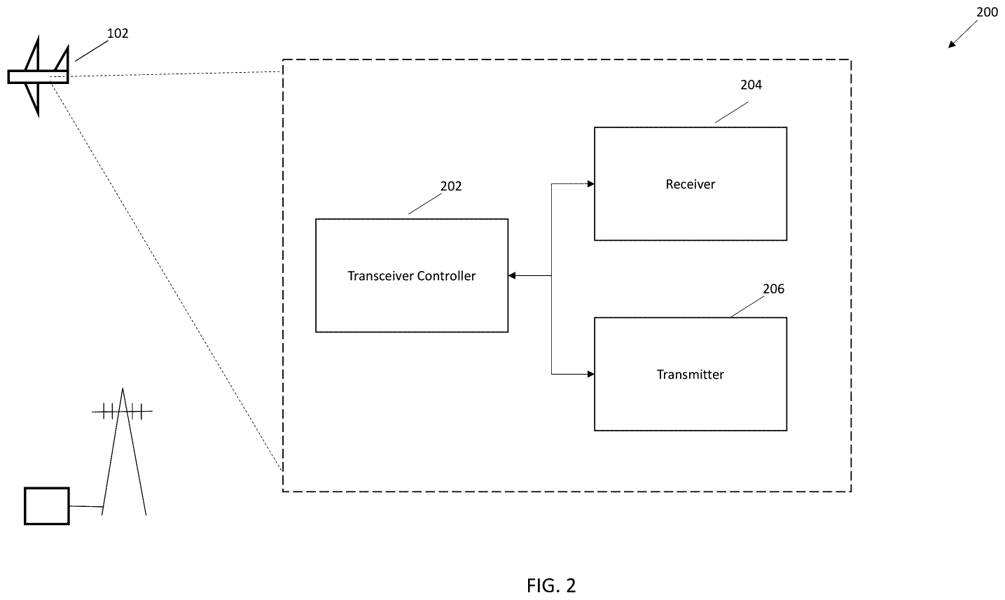

FIG. 2 illustrates an exemplary aircraft transceiver for receiving and transmitting remote identification transmissions according to one or more examples of the disclosure. As described above, in the system 100 of FIG. 1, each of the aircraft 102 can be outfitted with its own transceiver that in many respects operates like an airborne pager in a two-way paging system insofar as the transceiver is configured to receive broadcast traffic, determine that traffic is meant for the particular aircraft that the transceiver is associated with, and transmit response signals in a particular format that is in accordance with a format used by the system 100. In one or more examples, and as illustrated in FIG. 2, transceiver 200 (that is aboard aircraft 102) includes a receiver 204, a transmitter 206, and a controller 202.

In one or more examples, receiver 204 is configured to receive the interrogation signals transmitted by the one or more ground-based transceivers described above with respect to FIG. 1. Receiver 204 can be specifically configured to receive the interrogation signal according to an expected frequency of the signal, as well as an expected modulation of the interrogation signal. In some examples, receiver 204 can be part of a system that in addition to being used for secure remote identification and location tracking, can also be used by one or more pilots on the ground to issue commands to and control the aircraft 102.

In one or more examples, transmitter 206 is configured to transmit one or more response signals in response to a received interrogation signal received at receiver 204. Transmitter 206 can be specifically configured (by transceiver controller 202) to transmit a response signal in accordance with a carrier frequency, specific time, and modulation scheme that is determined by controller 202. In some examples, transmitter 206 can also be used to provide command and control information to one or more ground-based assets on the ground, in addition to acting as a transmitter in the context of airborne secure remote identification and location tracking.

In one or more examples, transceiver 200 includes a transceiver controller 202 that is communicatively coupled to both receiver 204 and transmitter 206 and is configured to operate both the receiver and transmitter to perform various operations associated with secure remote identification and location tracking. For instance, and as described in further detail below, controller 202 can parse interrogation signals received at receiver 204, format a response signal, and then cause the response signal to be transmitted to one or more ground-based transceivers by transmitter 206 in accordance with the transmit control information that is received as part of the received interrogation signal.

In one or more examples, the system 100 and the airborne transceiver 200 described above can work in conjunction with one another to collectively provide secure remote identification and location tracking for aircraft. As described in detail below, both the system 100 and airborne transceiver 200 implement methods that when implemented by the hardware described above lead to secure tracking of aircraft with minimal RF congestion.

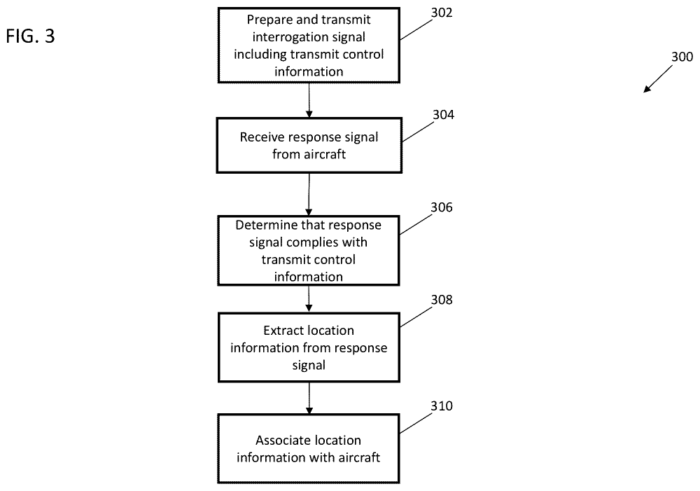

FIG. 3 illustrates an exemplary process for tracking an aerial vehicle using an aircraft remote tracking system according to one or more examples of the disclosure. The process 300 of FIG. 3 can be implemented by a system for tracking aircraft such as system 100 described above with respect to FIG. 3. In one or more examples the process 300 begins at step 302, wherein a controller (such as controller 108 of FIG. 1) prepares an interrogation signal and then causes each of the ground-based transceivers of the system (e.g., transceivers 104a-c) to broadcast/transmit the signal to one or more aircraft that are flying within the geographic coverage area of the system. In one or more examples, the interrogation signal includes address information that identifies which aircraft the interrogation signal is meant for. In one or more examples, the interrogation signal can be addressed to one or multiple aircraft flying through the airspace such that a single interrogation signal can have multiple response signals associated it with it.

In some examples, the interrogation signal transmitted at step 302 includes transmit control information. Transmit control information refers to information embedded in the interrogation signal that provides a specification for how any airborne transceivers responding to the interrogation signal (with a response signal described in further detail below) are to send the response signals. In some examples, the transmit control information can include specifications regarding: the carrier frequency at which to transmit the response signal, the modulation scheme to be used to transmit the response signal, the format of the response signal including where in the response signal particular location information should be embedded, and can also include timing information specifying one or more time windows during which the airborne transceiver should transmit the response signal to the ground-based transceivers of the system. The time windows can include a time at which the response signal is to be transmitted, a range of time during which the response signal is to be transmitted, or an amount of time after the interrogation signal is transmitted (i.e., delay) at which the response signal is to be transmitted. In some examples, the transmit control information and in particular the timing information can specify the time windows according to a deterministic sequence such as a periodic sequence with a certain frequency. Additionally or alternatively, the time windows can be specified according to a pseudo-random sequence (e.g., pseudo-random time windows) that can be unique to a particular aircraft of the aircraft flying in the coverage area, or unique to a particular group of aircraft within the coverage area.

In one or more examples, once the ground-based transceivers transmit the interrogation signal at step 302, the process 300 moves to step 304 wherein the ground-based transceivers receive one or more response signals from the aircraft that have been transmitted by one or more airborne transceivers in response to the interrogation signal transmitted at step 302. In one or more examples, after receiving the response signal from the aircraft at step 304, the process 300 moves to step 306, wherein a determination is made (for instance by controller 108 of system 100) as to whether the received response signal complies with the transmit control information (e.g., the specifications for the response signal described above) that was included as part of the interrogation signal. For instance, in one or more examples, the received response signal can be checked to determine if it complies with the frequency and modulation requirements that are associated with the transmit control information. In one or more examples, the received response signal can also be checked to see if it was received within a time window that was specified by the interrogation signal. In some examples, if a received response signal does not comply with the transmit control information specified in the interrogation signal, the system can determine that the received response signal is not authentic and can reject the received response signal. If a received response signal does not comply with the transmit control information, then it can likely mean that the originating transceiver where the response signal came from may not have had access to the transmit control signal thereby indicating that the received response signal is likely a spoofed signal from a source that is not the aircraft that the response signal purports to be from. Thus, the transmit control information transmitted as part of the interrogation signal can serve to authenticate response signals, since illegitimate sources of response signals may not have access to the transmit control information and thus would not be able to comply with the transmit specifications laid out in the interrogation signal for the response signal.

In one or more examples, once it has been determined that the response signal complies with the transmit control information at step 306, the process 300 moves to step 308 wherein the controller 108 extracts location information from the received response signal. In one or more examples, location information includes any type of information that can be used to track an aircraft including, but not limited to: the coordinates (latitude and longitude) of the aircraft, the speed of the aircraft, the direction of travel (e.g., heading) of the aircraft, and identification information (e.g., tail number, call sign, etc.) pertaining to the aircraft. In some examples, once the location information is extracted, the location information is associated with a particular aircraft flying in the coverage area of the system and is used to track the aircraft that is associated with the response signal received at step 310. In one or more examples, the extracted location information can be used to further authenticate the received response signal. For instance, the extracted location information can be compared against a filed flight plan associated with the aircraft to determine if the location information is in accordance with the flight plan.

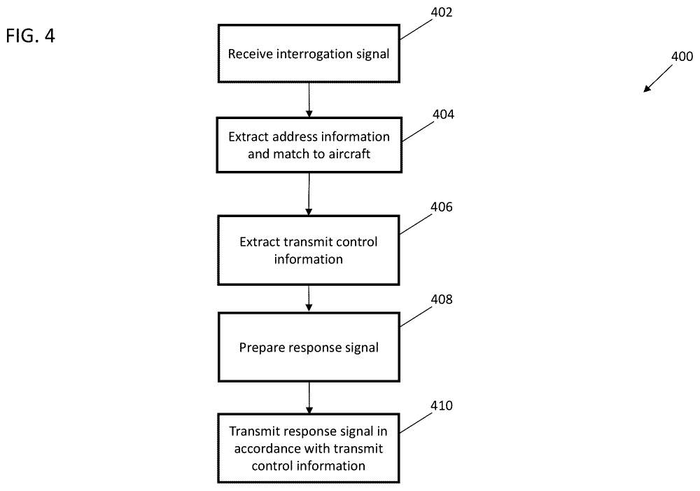

As described above, the system 100 of FIG. 1 can work in conjunction with the airborne transceiver 200 of FIG. 2, to provide secure and remote tracking for aircraft. Thus, in one or more examples, the airborne transceiver can be specifically configured to not only perform certain functions associated with the process 300 described above with respect to FIG. 3 but can also be configured to work with a ground-based transceiver that is also part of a two-way paging network. In some examples, the airborne transceiver 200 of FIG. 2 effectively operates as a two-way pager in a paging network, and the ground-based transceivers provide control information that dictates certain operational features of the airborne transceivers as described below with respect to FIG. 4.

FIG. 4 illustrates an exemplary process implemented by an airborne transceiver for providing tracking information to an aircraft remote tracking system according to one or more examples of the disclosure. The process 400 of FIG. 4 can be performed at an airborne transceiver such as airborne transceiver 200 described above with respect to FIG. 2. In one or more examples, the process 400 begins at step 402, wherein the airborne transceiver receives an interrogation signal from one or more ground-based transceivers 104a-c described above. The received interrogation signal shares one or more characteristics of the interrogation signals described above with respect to process 300 of FIG. 3. In some examples, and in response to receiving the interrogation signal at step 402, the airborne transceiver extracts address information from the interrogation signal and determines if the extracted address corresponds to the aircraft that the airborne transceiver is associated with at step 402. In some examples, the interrogation signals are broadcast by the network of ground-based transceivers, meaning that each aircraft flying in the geographic coverage area of the system will receive every broadcast interrogation signal, regardless of whether the interrogation signal is meant for that particular aircraft or another aircraft. Thus at step 404, the airborne transceiver extracts address information from the interrogation signal that identifies which aircraft the interrogational is meant for and only takes any action if at step 404, the airborne transceiver determines that interrogation signal is properly addressed to the aircraft associated with the airborne transceiver.

In one or more examples, once the airborne transceiver determines that the interrogation signal is addressed for the aircraft associated with the transceiver at step 404, the process 400 moves to step 406 wherein the airborne transceiver extracts transmit control information from the interrogation signal. In one or more examples, the transmit control information shares one or more characteristics with the transmit control information described above with respect to process 300 of FIG. 3. Thus, in one or more examples, the transmit control information includes instructions that the airborne transceiver will comply with when transmitting a response signal including but not limited to transmitting the response signals within one or more time windows that are delineated within the transmit control signals.

In one or more examples, once the airborne transceiver has extracted the transmit control information at step 406, the process 400 moves to step 408, wherein the airborne transceiver (and specifically controller 202) prepares a response signal that complies with the instructions delineated in the transmit control instructions. For instance, the controller 202 of the airborne transceiver, in accordance with the transmit control instructions can format the response signal in accordance with the transmit control instructions and include the information that the transmit control instructions require.

Once the response signal has been created at step 408, the process 400 moves to step 410 wherein the response signal is transmitted in accordance with the transmit control instructions. For instance, the transmitter 206 of transceiver 200 can transmit the response signal in accordance with the carrier frequency and/or modulation scheme that are included as part of the transmit control instructions. In one or more examples, and as described above, the airborne transceiver 200 transmits the response signal according to the time window that is specified by the transmit control instructions.

In one or more examples, the processes 300 and 400 described above can be used to implement a “round-robin” interrogation scheme in which the system 100 interrogates aircraft flying within the coverage area one at a time, or some at a given time. Using FIG. 1 as an example, the interrogation signal meant for aircraft 102 can specify a different time window for the response signal than the interrogation signal meant for aircraft 106. In this way, the likelihood of any signal collisions between the response signal transmitted by aircraft 102 and the response signal transmitted by aircraft 106 can be minimized. In one or more examples, the controller 108 can coordinate which aircraft is to transmit a response signal to the one or more ground-based transceivers at any given time based on the current or tracked location of the aircraft. For instance, using FIG. 1 as an example, controller 108 can specify that aircraft 102 and 106 can transmit their response signals during the same time window (by specifying the same time window in the transmit control information of the interrogation signal addressed to each aircraft). However, should aircraft 102 and 106 come into closer proximity with one another, such that the likelihood that their response signals will be received by the same set of ground-based receivers, then controller 108 can operate to ensure that the time windows for the response signals from aircraft 102 and 106 are separated in time from one another so as to avoid a signal collision between the response signals.

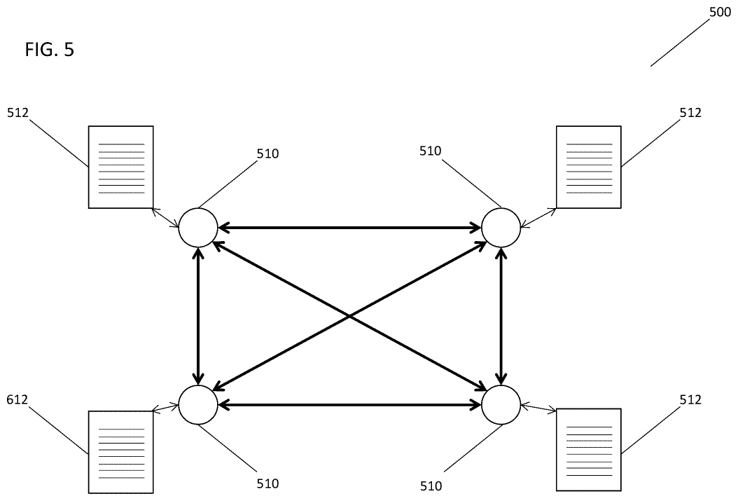

FIG. 5 illustrates an exemplary distributed ledger system according to examples of the disclosure. In one or more examples, distributed ledger 500 may include one or more distributed ledger nodes 510. The distributed ledger nodes 510 may be distributed in a decentralized form across one or more peoples, institutions, locations, and/or processors. In one or more examples, each node 510 of the distributed ledger 500 can include and maintain a ledger 512 that records data. Each distributed ledger node 510 follows the same protocol to maintain and update its associated ledger 512. For example, when distributed ledger 500 receives new data, the new data is sent to each distributed ledger node 510. Once an individual distributed ledger node 510 receives the new data, it may append this new data to the existing data stored in ledger 512 to form an input data, apply a cryptographic hash function to the input data to generate a hashed output, and store the hashed output to its associated ledger 512. By producing the hashed output using the existing data stored in ledger 512, distributed ledger 500 is able to create a sequential chain of cryptographic hash-linked data that act as a secure and immutable record of the historical ledger information.

Distributed ledger 500 is able to provide further security and verifiability by having each distributed ledger node 510 maintain its ledger 512 independently and then verifying that all distributed ledger nodes 510 result in the same ledger 512. In particular, distributed ledger 500 may be configured such that one or more of the distributed ledger nodes 510 may participate in a consensus with one or more other distributed ledger nodes 510 such that each distributed ledger node 510 in consensus uses the same protocol (e.g., same cryptographic hash function) to maintain and update its associated ledger 512. The distributed ledger nodes 510 that participate in a consensus may exchange ledger information to verify that each distributed ledger node 510 in consensus has the same data stored in its associated ledger 512. In one or more examples, distributed ledger 500 may use Byzantine Fault Tolerance (BFT) to achieve consensus. By having distributed ledger nodes 510 independently record and maintain ledger 512, distributed ledger 500 reduces the risk that an error or centralized attack may pose on the integrity of the data recorded in ledger 512. Distributed ledger 500 may generate a single data record by collecting ledger data from each ledger 512, and using the data that the most number of ledgers 512 agree on in the data record.

The configuration of distributed ledger 500 allows a system that employs distributed ledger 500 to be able to record data in a secure and immutable manner. Distributed ledger 500 could be employed in a secure remote identification and tracking system to generate a record of communications between airborne assets and the ground such that the record meets reliability, integrity and availability performance targets set forth by regulators. By employing distributed ledger 500 in an aviation communication network, the communication link between airborne assets and the ground could be more secure to outside threats, and can create an immutable record of the communications to be accessed and used by third parties due to regulatory or technical requirements.

In one or more examples, a secure remote identification system that includes the elements described above with respect to FIGS. 1 and 2 can be used to operate a distributed ledger system (i.e., each element can represent a node in a distributed ledger system). For instance, when an aircraft is initially registers with the system (i.e., the aircraft transmits a signal to the one or more ground-based transceivers to indicate that the aircraft is operating within the geographic coverage area of the system), the network controller 108 can initiate a process to create a distributed ledger for the aircraft that includes the aircraft, as well as one or more elements of the ground-based transceiver 104a-c. For instance, a distributed ledger can be created for each aircraft flying in the network that includes the airborne transceiver associated with the aircraft, the transmitter of the ground-based transceiver, and the receiver of the ground-based transceiver, all operating as nodes within the distributed ledger system. In some examples, the airborne transmitter can act as a single node within the distributed ledger system. In one or more examples, during operation of a flight within the coverage area of a secure remote identification and tracking system, the nodes can work together to maintain and operate separate copies of a ledger that records the transactions between ground-based transceivers and the airborne transceiver. For instance, the transactions can include the interrogation signals sent from the ground-based transceivers to the airborne receivers and can include the response signals sent from the airborne transceivers to the ground-based transceivers.

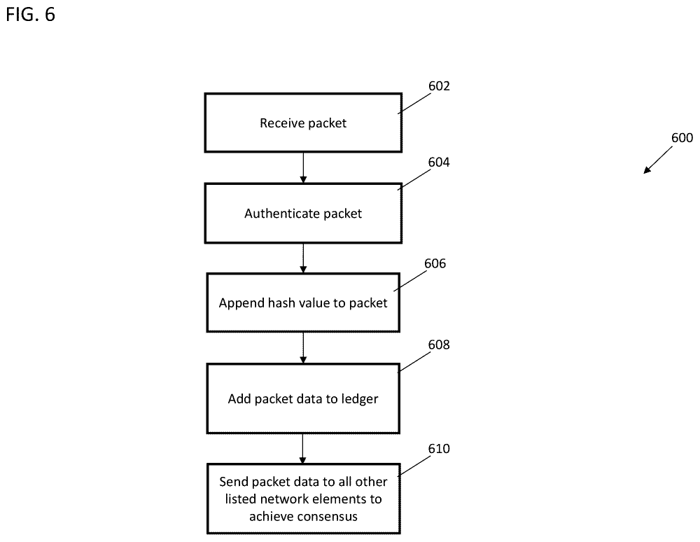

FIG. 6 illustrates an exemplary process for operating a distributed ledger system associated with an aircraft remote identification network according to one or more examples of the disclosure. Process 600 can begin at step 602, wherein a network element (e.g., node) such as the ground-based transceiver receives a transaction (such as a response signal).

In one or more examples, once the node receives the packet such as the response signal from an airborne transceiver, the process 600 moves to step 604, wherein the node authenticates the received packet. For instance, and similar to the examples described above, the ground-based transceiver can authenticate a response signal by checking to ensure that the received response signal complies with the transmit control information associated with the interrogation signal that was transmitted to the aircraft from which the response signal was received.

In one or more examples, once the node has authenticated the received packet, the node appends the data received in step 602 to the existing data stored in its ledger to form an input data, apply a cryptographic hash function to the input data to generate a hashed output, and append the hashed output to the data packet. In some examples, the cryptographic hash function used to generate the hashed output may depend on the direction the data packet is transmitted, the source of the data packet, and/or the destination of the packet, such that the hashed output may provide a record of the transmission history of a data packet. In some examples, the direction of the data packet depends on whether the data packet is transmitted from the aircraft to the ground-based transceivers or from the ground-based transceivers to the aircraft. In some examples, the cryptographic hash function may be a SHA1 function, and/or a MD5 function. In one or more examples, the network element may append a hashed output generated from one type of cryptographic hash function to incoming packets, and another hashed output generated from another type of cryptographic hash function to outgoing packets. In one or more examples, the type of cryptographic hash function used to generate the hash values appended to one packet may be used to determine the direction, source network element that transmitted the packet, and/or target network element that received the packet.

In one or more examples, once the hash value has been appended to the packet at step 606, the process 600 can move to step 606, wherein the node may transform data from the packet generated from received at step 602 to a data structure and store the data structure in a ledger associated with the network element. After the network element adds the data structure to its ledger at step 608, in one or more examples, the network element continues to step 610 to reach consensus with the other nodes participating in consensus. To reach consensus, the network element can send a copy of the data structure to other nodes participating in consensus such that the other network elements may update their associated ledgers with the data structure to achieve consensus.

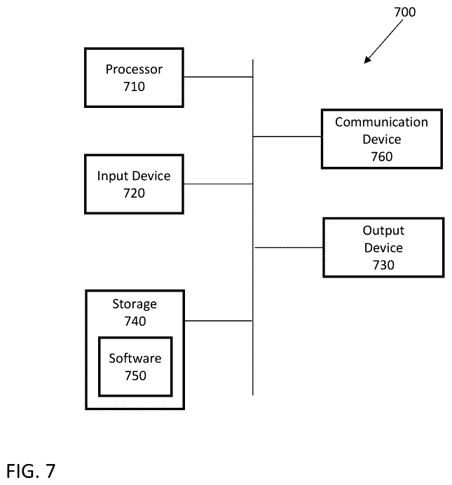

FIG. 7 illustrates an exemplary computing system, according to examples of the disclosure. FIG. 7 illustrates an example of a computing system 700, in accordance with some examples system 700 can be a client or a server. As shown in FIG. 7, system 700 can be any suitable type of processor-based system, such as a personal computer, workstation, server, handheld computing device (portable electronic device) such as a phone or tablet, or dedicated device. The system 700 can include, for example, one or more of input device 720, output device 730, one or more processors 710, storage 740, and communication device 760. Input device 720 and output device 730 can generally correspond to those described above and can either be connectable or integrated with the computer.

Input device 720 can be any suitable device that provides input, such as a touch screen, keyboard or keypad, mouse, gesture recognition component of a virtual/augmented reality system, or voice-recognition device. Output device 730 can be or include any suitable device that provides output, such as a display, touch screen, haptics device, virtual/augmented reality display, or speaker.

Storage 740 can be any suitable device that provides storage, such as an electrical, magnetic, or optical memory including a RAM, cache, hard drive, removable storage disk, or other non-transitory computer readable medium. Communication device 760 can include any suitable device capable of transmitting and receiving signals over a network, such as a network interface chip or device. The components of the computing system 700 can be connected in any suitable manner, such as via a physical bus or wirelessly.

Processor(s) 710 can be any suitable processor or combination of processors, including any of, or any combination of, a central processing unit (CPU), field programmable gate array (FPGA), and application-specific integrated circuit (ASIC). Software 750, which can be stored in storage 740 and executed by one or more processors 710, can include, for example, the programming that embodies the functionality or portions of the functionality of the present disclosure (e.g., as embodied in the devices as described above)

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 700 can implement any operating system suitable for operating on the network. Software 750 can be written in any suitable programming language, such as C, C++, Java, or Python. In various examples, application software embodying the functionality of the present disclosure can be deployed in different configurations, such as in a client/server arrangement or through a Web browser as a Web-based application or Web service, for example.

Some examples of the disclosure are directed to a system for identifying and tracking unmanned aerial vehicles, the system comprising: a plurality of ground-based transceivers, wherein the plurality of ground-based transceivers are distributed within a geographic coverage area, a memory, and one or more processors, wherein each processor of the one or more processors is communicatively coupled to each of the plurality of ground-based transceivers, wherein the memory stores one or more programs that when executed by the one or more processors, cause the one or more processors to: transmit an interrogation signal to one or more aircraft flying within the geographic coverage area from one or more of the transceivers of the plurality of ground-based transceivers, wherein the interrogation signal includes transmit control information, and wherein the transmit control information includes instructions for a manner in which a transceiver located on the one or more aircraft is to transmit a response to the interrogation signal to the one or more ground-based transceivers, receive a response signal from a transceiver associated with an aircraft of the one or more aircraft flying within the geographic coverage area, wherein the response signal is received at a least one of the plurality of ground based transceivers, in response to receiving the receiving the response signal, determining that the received response signal complies with the transmit control information included as part of the transmitted interrogation signal, and in accordance with the determination the received response signal complies with the transmit control information, associating an aircraft of the one or more aircraft with location information included as part of the received response signal.

Optionally, the transmitted interrogation signal comprises an address portion, and wherein the address portion is configured to allow an aircraft of the one or more aircraft to determine that the transmitted interrogation signal is addressed to the aircraft.

Optionally, the transmit control information comprises timing instructions, and wherein the timing instructions specify one or more transmission time windows during which the transceiver of the aircraft is to transmit the response signal.

Optionally, the timing instructions specify the one or more transmission time windows according to a pseudo-random sequence.

Optionally, the timing instructions specify a different pseudo-random sequence for each aircraft of the one or more aircraft.

Optionally, the timing instructions specify the one or more transmission time windows according to a deterministic sequence.

Optionally, the transmit control information comprises frequency information, and wherein the frequency information specifies one or more frequencies that the transceiver of the aircraft is to use when transmitting the response signal.

Optionally, the one or more processors, the one or more of the ground-based transceivers of the plurality of ground-based transceivers, and the transceiver associated with the aircraft collectively form and maintain a distributed ledger.

Optionally, the compliance of the received response signal with the transmit control information included as part of the transmitted interrogation signal is used to authenticate one or more transactions associated with the distributed ledger system.

Optionally, the transmit control information comprises hashing information, and wherein the hashing information specifies a hashing function that is to be applied to the response signal when transmitted by the transceiver of the aircraft.

Optionally, the received location information comprises one or more geographic coordinates associated with a location of the aircraft.

Optionally, the received location information comprises aircraft identification information.

Optionally, the plurality of ground-based transceivers are configured to operate as transceivers in a two-way paging network.

One or more examples of the disclosure are directed to an electronic device configured to transmit one or more response signals in response to receiving one or more interrogation signals from one or more ground-based transceivers, the electronic device comprising: a receiver configured to receive the one or more interrogation signals from the one or more ground-based transceivers, a transmitter configured to transmit the one or more response signals, a memory, and one or more processors, wherein the memory stores one or more programs that when executed by the one or more processors, cause the one or more processors to: receive an interrogation signal from one or more ground-based transceivers of a plurality of ground-based transceivers distributed within a geographic coverage area, wherein the interrogation signal includes transmit control information, and wherein the transmit control information includes instructions for a manner in which the transmitter is to transmit a response signal to the interrogation signal to the one or more ground-based transceivers, and transmit a response signal to the one or more ground-based transceivers, wherein the transmitter transmits the response signal in accordance with the received transmit control instructions, and wherein the response signal comprises location information associated with the electronic device.

Optionally, the received interrogation signal comprises an address portion, and wherein the address portion is configured to allow the electronic device to determine that the transmitted interrogation signal is addressed to the electronic device.

Optionally, the transmit control information comprises timing instructions, and wherein the timing instructions specify one or more transmission time windows during which the transceiver of the aircraft is to transmit the response signal.

Optionally, the timing instructions specify the one or more transmission time windows according to a pseudo-random sequence.

Optionally, the timing instructions specify a different pseudo-random sequence for each electronic device of a plurality of electronic devices.

Optionally, the timing instructions specify the one or more transmission time windows according to a deterministic sequence.

Optionally, the transmit control information comprises frequency information, and wherein the frequency information specifies one or more frequencies that the electronic device is to use when transmitting the response signal.

Optionally, the electronic device, and the one or more of the ground-based transceivers collectively form and maintain a distributed ledger.

Optionally, a compliance of the transmitted response signal with the transmit control information included as part of the received interrogation signal is used to authenticate one or more transactions associated with the distributed ledger system.

Optionally, the transmit control information comprises hashing information, and wherein the hashing information specifies a hashing function that is to be applied to the response signal when transmitted by the transmitter of the electronic device.

Optionally, the received location information comprises one or more geographic coordinates associated with a location of the aircraft.

Optionally, the transmitted location information comprises aircraft identification information.

Optionally, the plurality of ground-based transceivers are configured to operate as transceivers in a two-way paging network.

The foregoing description, for the purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated. For the purpose of clarity and a concise description, features are described herein as part of the same or separate examples; however, it will be appreciated that the scope of the disclosure includes examples having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A system for identifying and tracking unmanned aerial vehicles, the system comprising:
a plurality of ground-based transceivers, wherein the plurality of ground-based transceivers are distributed within a geographic coverage area;
a memory; and
one or more processors, wherein each processor of the one or more processors is communicatively coupled to each of the plurality of ground-based transceivers;
wherein the memory stores one or more programs that when executed by the one or more processors, cause the one or more processors to:
transmit an interrogation signal to one or more aircraft flying within the geographic coverage area from one or more of the transceivers of the plurality of ground-based transceivers, wherein the interrogation signal includes transmit control information, and wherein the transmit control information includes instructions for a manner in which a transceiver located on the one or more aircraft is to transmit a response to the interrogation signal to the one or more ground-based transceivers;
receive a response signal from a transceiver associated with an aircraft of the one or more aircraft flying within the geographic coverage area, wherein the response signal is received at a least one of the plurality of ground based transceivers; and
in response to the response signal, determining that the received response signal complies with the transmit control information included as part of the transmitted interrogation signal.

2. The system of claim 1, wherein the one or more programs further cause the one or more processors to: in accordance with the determination the received response signal complies with the transmit control information, associate an aircraft of the one or more aircraft with location information included as part of the received response signal.

3. The system of claim 1, wherein the transmitted interrogation signal comprises an address portion, and wherein the address portion is configured to allow an aircraft of the one or more aircraft to determine that the transmitted interrogation signal is addressed to the aircraft.

4. The system of claim 1, wherein the transmit control information comprises timing instructions, and wherein the timing instructions specify one or more transmission time windows during which the transceiver of the aircraft is to transmit the response signal.

5. The system of claim 4, wherein the timing instructions specify the one or more transmission time windows according to a pseudo-random sequence.

6. The system of claim 5, wherein the timing instructions specify a different pseudo-random sequence for each aircraft of the one or more aircraft.

7. The system of claim 4, wherein the timing instructions specify the one or more transmission time windows according to a deterministic sequence.

8. The system of claim 1, wherein the transmit control information comprises frequency information, and wherein the frequency information specifies one or more frequencies that the transceiver of the aircraft is to use when transmitting the response signal.

9. A method for identifying and tracking unmanned aerial vehicles, the method comprising:
transmitting an interrogation signal to one or more aircraft flying within a geographic coverage area associated with one or more transceivers of a plurality of ground-based transceivers, wherein the interrogation signal includes transmit control information, and wherein the transmit control information includes instructions for a manner in which a transceiver located on the one or more aircraft is to transmit a response to the interrogation signal to the one or more ground-based transceivers;
receiving a response signal from a transceiver associated with an aircraft of the one or more aircraft flying within the geographic coverage area, wherein the response signal is received at a least one of the plurality of ground based transceivers; and
in response to receiving the response signal, determining that the received response signal complies with the transmit control information included as part of the transmitted interrogation signal.

10. The method of claim 9, wherein the method further comprises: in accordance with the determination the received response signal complies with the transmit control information, associate an aircraft of the one or more aircraft with location information included as part of the received response signal.

11. The method of claim 9, wherein the transmitted interrogation signal comprises an address portion, and wherein the address portion is configured to allow an aircraft of the one or more aircraft to determine that the transmitted interrogation signal is addressed to the aircraft.

12. The method of claim 9, wherein the transmit control information comprises timing instructions, and wherein the timing instructions specify one or more transmission time windows during which the transceiver of the aircraft is to transmit the response signal.

13. The method of claim 12, wherein the timing instructions specify the one or more transmission time windows according to a pseudo-random sequence.

14. The method of claim 13, wherein the timing instructions specify a different pseudo-random sequence for each aircraft of the one or more aircraft.

15. The method of claim 12, wherein the timing instructions specify the one or more transmission time windows according to a deterministic sequence.

16. The method of claim 9, wherein the transmit control information comprises frequency information, and wherein the frequency information specifies one or more frequencies that the transceiver of the aircraft is to use when transmitting the response signal.

17. A non-transitory computer readable storage medium storing one or more programs for identifying and tracking unmanned aerial vehicles, for execution by one or more processors of an electronic device that when executed by the device, cause the device to:
transmit an interrogation signal to one or more aircraft flying within a geographic coverage area associated with one or more transceivers of a plurality of ground-based transceivers, wherein the interrogation signal includes transmit control information, and wherein the transmit control information includes instructions for a manner in which a transceiver located on the one or more aircraft is to transmit a response to the interrogation signal to the one or more ground-based transceivers;
receive a response signal from a transceiver associated with an aircraft of the one or more aircraft flying within the geographic coverage area, wherein the response signal is received at a least one of the plurality of ground based transceivers; and
in response to receiving the response signal, determine that the received response signal complies with the transmit control information included as part of the transmitted interrogation signal.

18. The non-transitory computer readable storage medium of claim 17, wherein the device is further caused to: in accordance with the determination the received response signal complies with the transmit control information, associate an aircraft of the one or more aircraft with location information included as part of the received response signal.

19. The non-transitory computer readable storage medium of claim 17, wherein the transmitted interrogation signal comprises an address portion, and wherein the address portion is configured to allow an aircraft of the one or more aircraft to determine that the transmitted interrogation signal is addressed to the aircraft.

20. The non-transitory computer readable storage medium of claim 17, wherein the transmit control information comprises timing instructions, and wherein the timing instructions specify one or more transmission time windows during which the transceiver of the aircraft is to transmit the response signal.

21. The non-transitory computer readable storage medium of claim 20, wherein the timing instructions specify the one or more transmission time windows according to a pseudo-random sequence.

22. The non-transitory computer readable storage medium of claim 21, wherein the timing instructions specify a different pseudo-random sequence for each aircraft of the one or more aircraft.

23. The non-transitory computer readable storage medium of claim 20, wherein the timing instructions specify the one or more transmission time windows according to a deterministic sequence.

24. The non-transitory computer readable storage medium of claim 17, wherein the transmit control information comprises frequency information, and wherein the frequency information specifies one or more frequencies that the transceiver of the aircraft is to use when transmitting the response signal.
